(19) United States
(12) Patent Application Publication
(10) Pub. No.: US 2006/0283109 A1
(43) Pub. Date: Dec. 21, 2006

(54) Tenoning structure for a frame body of an aluminum door/window

(76) Inventor: Chen-Feng Lin, Jhanghe City (TW)

Correspondence Address: Troxell Law Office Pllc;Suite 1404, 5205 Leesburg Pike, Falls Church, VA, 22041, US

(21) Appl. No.: 11/242,881

(22) Filed: Oct. 5, 2005

(30) Foreign Application Priority Data
Jun. 16, 2005 (TW) 094210123

(51) Int. Cl. E06B 3/00

(52) U.S. Cl. 52/204.5

(57) ABSTRACT

A tenoning structure is composed of a stage at a bottom of a glass clipping groove of a left and a right vertical frame, and a plurality of notch grooves and latch ribs is located on the inside and outside plates. A positioning groove is located on an inside surface of the upper and lower horizontal frame, cuttings are located at two ends of an outside surfaces, and a rib is located at a top end of two side plates of the glass clipping groove of the horizontal frames, such that the two end surfaces of the upper and lower horizontal frames can be pressed against the stages of the left and right vertical frames, and the latching ribs of the vertical frames can be latched into the horizontal frames, in order to construct a tenoning structure for a frame body of the aluminum door/window.

### BACKGROUND OF THE INVENTION

(a) Field of the Invention

The present invention relates to a tenoning structure for a frame body of an aluminum door/window and more particularly to a tenoning structure constructed at each corner of a window frame With grooves and tenons of a frame extrusion itself, such that the window frame can be more reinforced.

(b) Description of the Prior Art

An aluminum door/window has now been commonly used in buildings and greatly appreciated by a general public, with its structure and quality being paid attention to correspondingly. However, a conventional frame body assembling structure of the aluminum door/window is made by screwing to screw holes of a frame extrusion at corners connecting an upper and a lower horizontal frame with a left and a right vertical frame. In addition, for a general implementation procedure of the aluminum door/window, it is first assembled in a factory and then shipped to an implementation place for installing, and is finally installed with a glass. As the frame body is only screwed at corners, its strength is relatively weak and is very easy to be deformed or damaged during shipping, thereby causing an inconvenience to implementation, lowering a working efficiency, and increasing an unnecessary waste in cost.

Accordingly, a tenoning structure for a frame body of an aluminum door/window is invented wherein a tenoning structure is created for assembling by a means of a design of a frame extrusion itself, thereby reinforcing the frame body structure of the aluminum door/window, in order to increase its quality.

### SUMMARY OF THE INVENTION

The primary object of the present invention is to provide a tenoning structure for a frame body of an aluminum door/window, such that the aluminum door/window is provide with a more reinforced and rigid frame body, in order to increase its quality.

Another object of the present invention is to provide a tenoning structure for a frame body of an aluminum door/window, which can be used to perform a preliminary fixing with grooves and tenons upon assembling a window frame.

Yet another object of the present invention is to provide a tenoning structure for a frame body of an aluminum door/Window, wherein the frame body can be preliminarily assembled after connecting grooves with tenons by a design of the frame itself, without using other connecting elements, such that a rotating can be performed more conveniently upon assembling a window frame in a factory, thereby increasing a manufacturing speed and lowering its manufacturing cost.

Accordingly, the present invention includes a stage at a bottom of glass clipping groove of a left and a right vertical frame, and a plurality of notch grooves latched correspondingly to cross sections of an upper and a lower horizontal frame located on an inside and an outside plate at two ends of the clipping groove, such that the inside and outside plates can form a plurality of latching ribs. A positioning groove is located at an inside surface of the upper and lower horizontal frame, a notch corresponding to the aforementioned stage at the bottom of the vertical frame is located at two ends of an outside surface, and a rib is located at a bottom of an outside plate of the glass clipping groove of the lower horizontal frame. By a means of the aforementioned structure, the frames can be mutually glided and connected, such that the two end surfaces of the upper and lower horizontal frames can be pressed against on the stages of the left and right vertical frames, the latching ribs of the vertical frames can be latched into the horizontal frames and be screwed into screw holes located on the two horizontal frames with screws, such that a tenoning structure for a frame body of an aluminum door/window can be constructed, thereby forming a more reinforced and rigid frame body of an aluminum door/window, in order to increase quality of a window frame and to reduce its manufacturing cost.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention

FIG. 2 shows a schematic view of disassembling compartments of the present invention.

FIG. 3 shows a longitudinal cutaway view after assembling the present invention.

FIG. 4 shows a transversal cutaway view after assembling the present invention.

FIG. 5 shows a perspective view of the present invention after assembling.

FIG. 6 shows a schematic view of an implementation of the present invention.

### DETAILED DESCRIPTION OF THE PREFERRED EMBODIMENTS

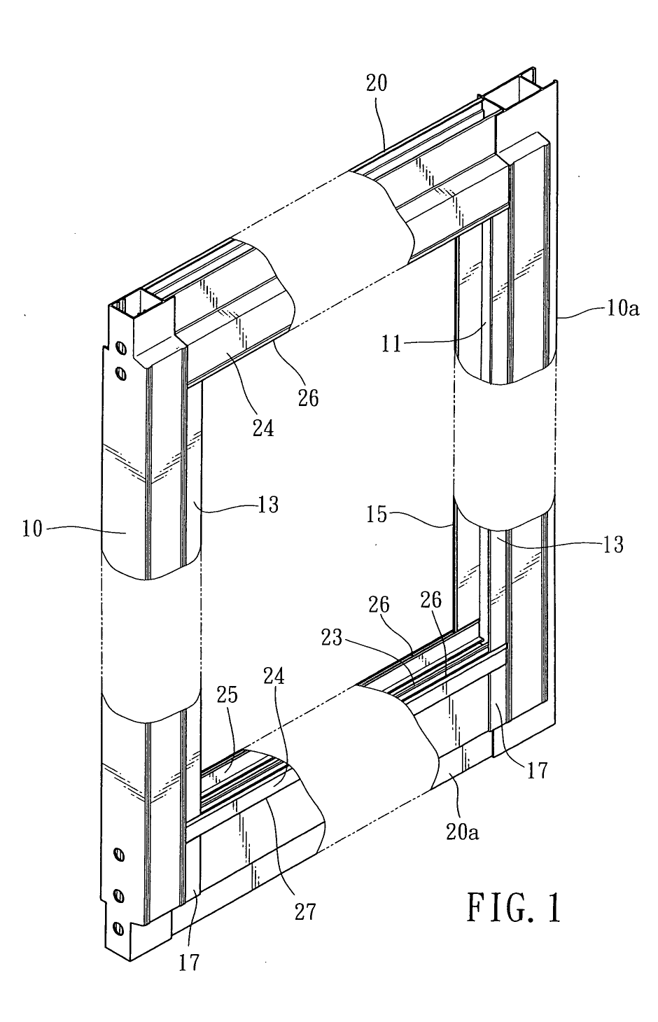

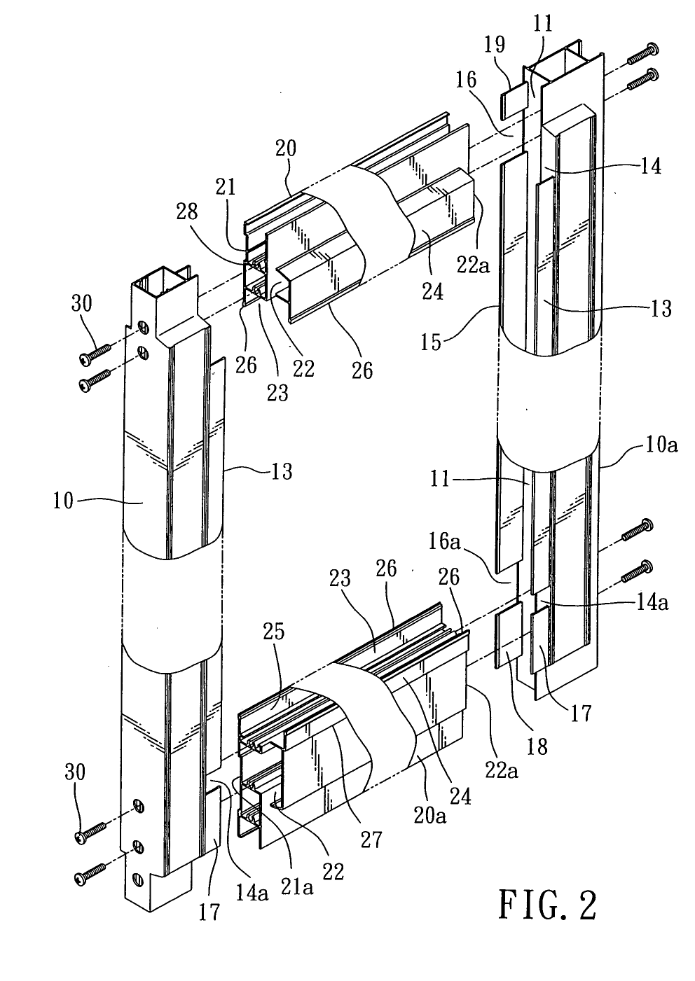

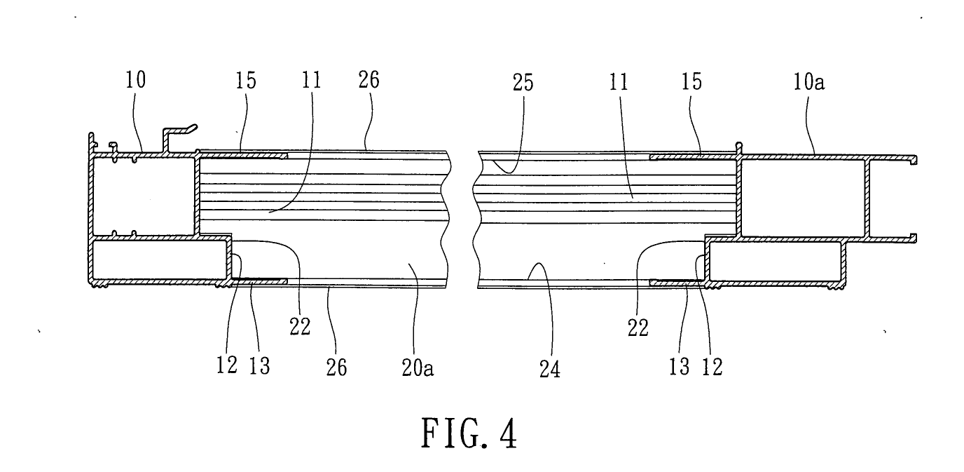

Referring to FIGS. 1 to 4, a tenoning structure for a frame body of an aluminum door/window is composed of a left vertical frame 10, a right vertical frame 10a, an upper horizontal frame 20, and a lower horizontal frame 20a, wherein a stage (as shown in FIG. 4) is located at a bottom of a glass clipping groove 11 of the aforementioned left vertical frame 10 and the right vertical frame 10a, notch grooves 14, 14a are located two ends of an outside plate 13 of the clipping groove 11, and other notch grooves 16, 16a are located at two ends of an inside plate 15. By a means of the aforementioned installation of the notch grooves, a plurality of latching ribs 17, 18 are formed at a bottom of the outside plate 13, and a latching rib 19 is formed at a top end of the inside plate 15.

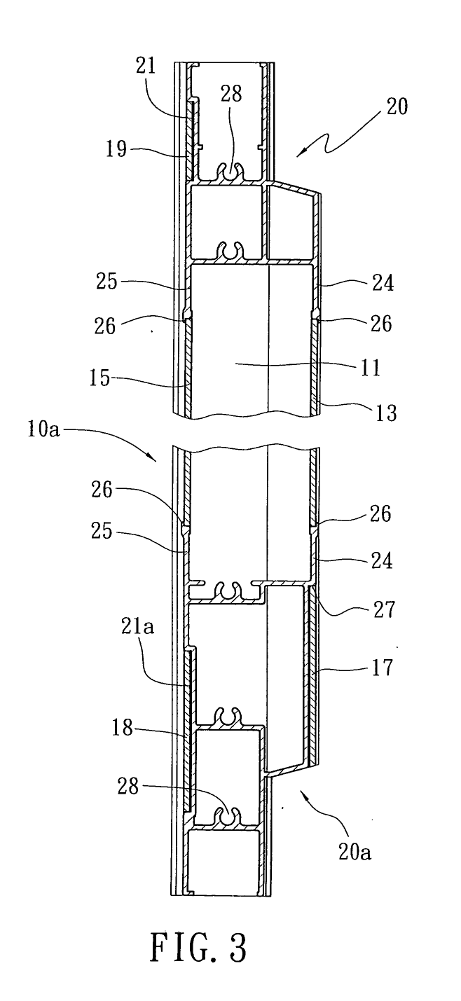

Positioning grooves 21, 21a (as shown in FIG. 3) are located at concave plates of inside surfaces of the upper and lower horizontal frames 20, 20a, and cuttings 22, 22a are located at two ends of outside surfaces, such that the cuttings 22, 22a can be assembled with the aforementioned stages 12 at the bottom of grooves of the vertical frames (as shown in FIG. 4). A rib 26 is located at a bottom of an inside plate 25 and an outside plate of the aforementioned upper horizontal frame 20, as well as at an inner and outer rim of the glass clipping groove 23. In addition, a stage rim 27 is located at a bottom of an outside plate 24 of the glass clipping groove 23 of the lower horizontal frame 20.

Upon assembling, the frames are mutually glided and connected, such that the cuttings 22, 22a at two end surfaces of the upper and lower horizontal frames 20, 20a are pressed against the stages 12 of the left and right vertical frames 10, 10a (as shown in FIG. 4), the latching ribs 17 at the bottom of the vertical frames are latched into the stage rims 27 at the bottom of outside plate 24 of the lower horizontal frame 20a, the latching rib 18 is latched into the positioning groove 21a of the inside plate 25 of the lower horizontal frame 20a, the lower end surfaces of the outside and inside plates 13, 15 of the vertical frames are latched into the rib 26 of the lower horizontal frame 20a, the latch rib 19 is latched into the positioning groove 21 inside the upper horizontal frame 20, and the upper end surfaces of the outside and inside plates 13, 15 of the vertical frames are latched into the rib 16 of the upper horizontal frame 20, thereby constructing a tenoning structure for a frame body of an aluminum door/window. In addition, the frame body can be prevented from gliding and loosening toward two sides by screwing screws 30 into screw holes 28 located at the two horizontal frames.

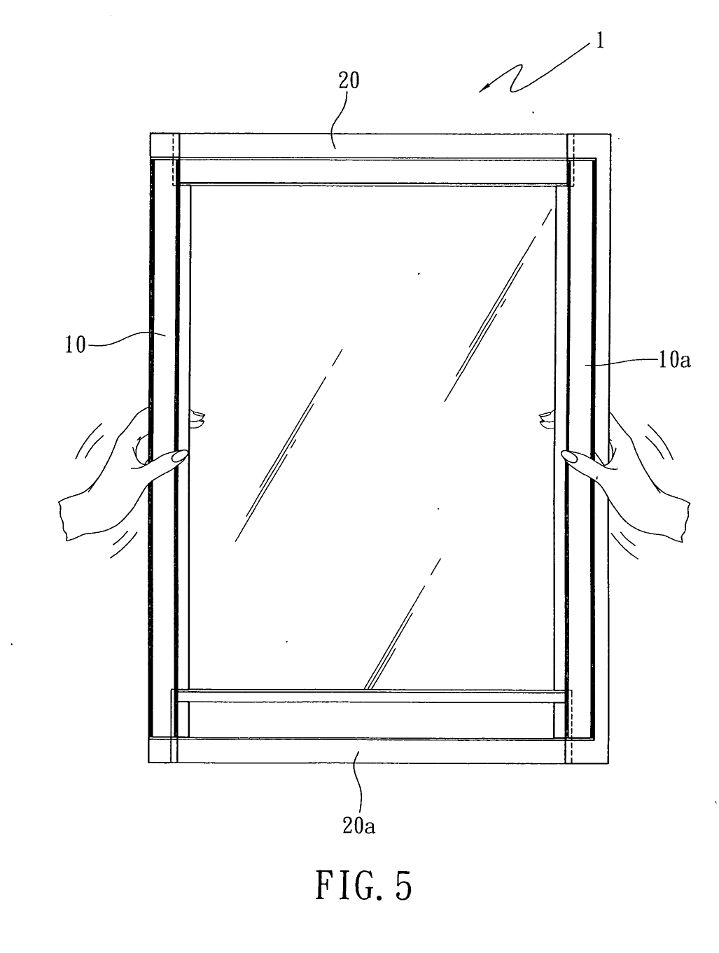

Referring to FIG. 5, it shows a frame body of an aluminum door/window 1 after being assembled. Due to the tenoning structure at corners of the frame body, there will be no deformation or damage to the frame body by exerting an inadequate force upon shipping, and a twisting force at a front and rear side of two opposite corners can also be resisted, thereby enabling the frame body to be more reinforced and rigid, in order to increase its quality.

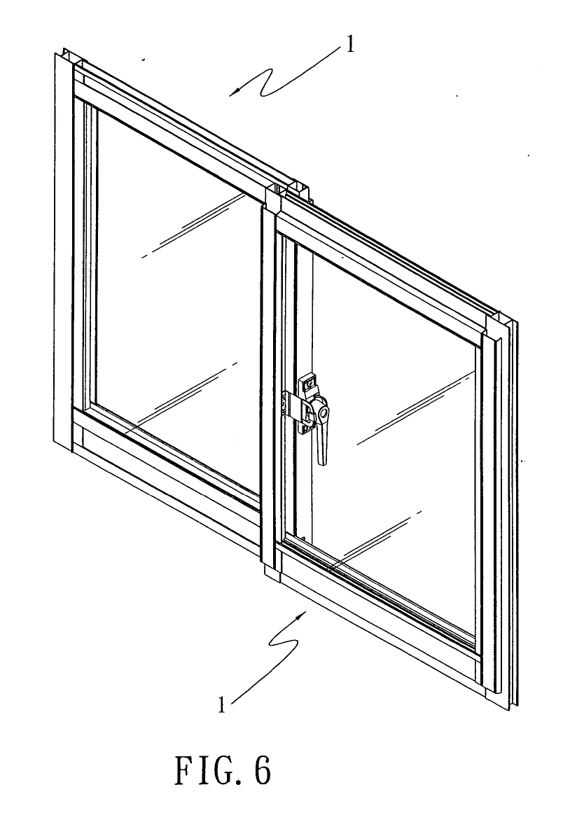

Referring to FIG. 6, it shows an implementation of the present invention. Due to the reinforced tenoning structure of the frame body, a better stability can be available upon pushing and pulling a window, and the lifespan of use of the window can be extended.

Accordingly, in the tenoning structure for a frame body of an aluminum door/window of the present invention, a design of a frame extrusion itself is used, such that it can be easily and quickly tenoned and assembled without using other connecting elements, and can also construct a reinforced frame body.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A tenoning structure for a frame body of an aluminum door/window, comprising a pair of left and right vertical frames and a pair of upper and lower frames, characterized in that a stage is located at a bottom of a glass clipping groove of the left and right vertical frame, and a plurality of notch grooves are located on an inside and an outside plate at two ends of the clipping groove, such that the notch grooves are latched correspondingly to the cross section of the upper and the lower horizontal frames, and the latch ribs are formed on an inside and an outside plate of the left and right vertical frames; a positioning groove are located at an inside surface of the upper and lower horizontal frames, and cuttings are located at two ends of an outside surface, such that the cuttings can be assembled correspondingly with stages at the bottom of grooves of the vertical frames; a rib is located at a top end of two side plates of the glass clipping grooves of the horizontal frames, and a stage rim is located at a bottom of an outside plate of the glass clipping groove of the lower horizontal frame; two end surfaces of the upper and lower horizontal frames are pressed against the stages of the left and right vertical frames, and the latching ribs of the vertical frames are latched into the horizontal frames, by mutually gliding and assembling the frames.
